(19) United States
(12) Patent Application Publication
(10) Pub. No.: US 2026/0180316 A1
(43) Pub. Date: Jun. 25, 2026

(54) ADAPTIVE CLAMP CIRCUIT

(71) Applicant: TEXAS INSTRUMENTS INCORPORATED, Dallas, TX (US)

(72) Inventors: Richeek MAITRA, Bangalore (IN); Ashish OJHA, Bangalore (IN)

(21) Appl. No.: 18/989,120

(22) Filed: Dec. 20, 2024

(51) Int. Cl. H02H 9/00; H01F 27/40

(52) U.S. Cl. CPC H02H 9/001; H01F 27/402; H01F 2027/406; H01F 2027/408

(57) ABSTRACT

A circuit includes first, second, and third transistors, and a current limit circuit. The first transistor has a first terminal, a second terminal, and a control terminal. The second transistor has a first terminal coupled to the first terminal of the first transistor, a second terminal, and a control terminal coupled to the control terminal of the first transistor. The third transistor has a first terminal coupled to the control terminal of the first transistor, a second terminal coupled to the second terminal of the first transistor, and a control terminal. The current limit circuit has a first terminal coupled to the second terminal of the second transistor, and a second terminal coupled to the control terminal of the third transistor.

### BACKGROUND

Inductive actuators, such as solenoids, are used in a wide variety of applications to convert electrical signals into mechanical movement. A solenoid includes a coiled conductor (a coil), a magnetically conductive rod, and a spring. The rod is positioned inside the coil and held in an inactive position by the spring. When current passes through the coil, a magnetic field is created, which causes the rod to move relative to the coil (move from the inactive position to an active position). When no current is flowing through the coil, the spring returns the rod to the inactive position. Systems using inductive actuators include driver circuits that control the inductive actuators.

### SUMMARY

In one example, a circuit includes first, second, and third transistors, and a current limit circuit. The first transistor has a first terminal, a second terminal, and a control terminal. The second transistor has a first terminal coupled to the first terminal of the first transistor, a second terminal, and a control terminal coupled to the control terminal of the first transistor. The third transistor has a first terminal coupled to the control terminal of the first transistor, a second terminal coupled to the second terminal of the first transistor, and a control terminal. The current limit circuit has a first terminal coupled to the second terminal of the second transistor, and a second terminal coupled to the control terminal of the third transistor.

In another example, a circuit includes first and second transistors, a current sensor, a filter circuit, and an amplifier. The first transistor has a first terminal, a second terminal, and a control terminal. The current sensor is coupled to the first terminal or the second terminal of the first transistor. The filter circuit has a first terminal coupled to current sensor, and a second terminal coupled to the second terminal of the first transistor, and a third terminal. The amplifier has a first input coupled to the third terminal of the filter circuit, a second terminal coupled to a slope input terminal, and an output. The second transistor has a first terminal coupled to the control terminal of the first transistor, a second terminal coupled to the second terminal of the first transistor, and a control terminal coupled to the output of the amplifier.

In a further example, an actuator circuit includes a pass transistor and a clamp control circuit. The pass transistor having a first terminal, a second terminal, and a control terminal, the pass transistor is configured to pass an actuation current, and clamp a voltage across the pass transistor. The clamp control circuit has a first terminal coupled to the first terminal of the pass transistor, a second terminal coupled to the second terminal of the pass transistor, and a third terminal coupled to the control terminal of the pass transistor. The clamp control circuit is configured to control a voltage at the control terminal of the pass transistor during clamping based on a slope of current flow through the pass transistor during clamping.

### BRIEF DESCRIPTION OF THE DRAWINGS

FIGS. 1A and 1B are schematic diagrams of an example driver circuits for an inductive actuator.

FIG. 2 is a schematic diagram showing detail of an example of the driver circuit of FIG. 1B.

FIG. 3 is a schematic diagram of example slope control circuitry suitable for use in the driver circuits of FIG. 1 or 2.

FIG. 4A is a graph of example signals in the driver circuits of FIG. 1 or 2.

FIG. 4B is a graph of example transistor temperature during clamping in the driver circuits of FIG. 1 or FIG. 2.

FIG. 5 is a block diagram of example vehicular active suspension system that include the driver circuit of FIG. 1 or 2.

### DETAILED DESCRIPTION

Driver circuits for controlling inductive actuators are subject to a variety of operational challenges. For example, when the driver circuit turns off an inductive actuator, the current flowing from the coil of the inductive actuator must be safely discharged using clamping provided by the driver circuit. The driver circuit may include transistors to control the inductive actuator. Because the current flowing from the inductive actuator can be relatively large, the transistor is sized to accommodate the power dissipated by the transistor during clamping. High power dissipation can cause an increase in the temperature of the transistor that can lead to damage or failure. Multiple clamping cycles with high temperature can increase the likelihood of transistor damage or failure. In some driver circuits, the size of the transistor is increased to allow for greater power dissipation, and reduced likelihood of damage. However, increasing transistor size increases circuit size and cost.

The driver circuit described herein includes circuitry that controls the rate of current decay when an inductive actuator is turned off such that the transistor clamping the current operates in the safe region as the current decays. The driver circuit may also monitor the temperature of the transistor, and adjust the rate of current decay based on the temperature of the transistor. By controlling the rate of current decay, the number of discharge cycles over which the transistor operates (the operational life of the driver circuit) is significantly increased.

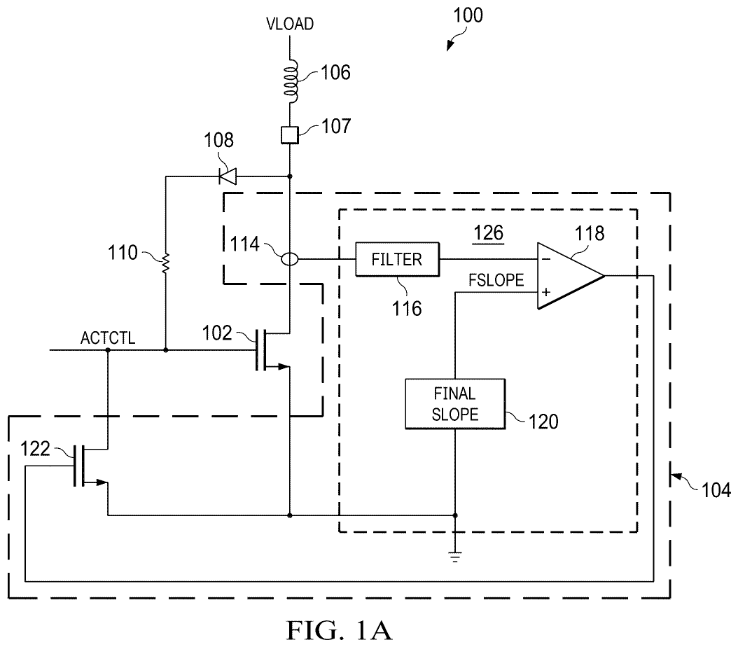

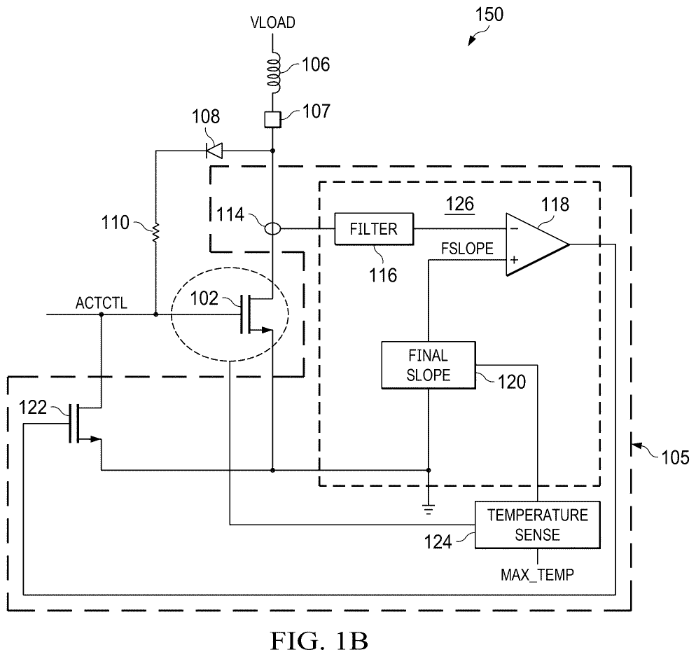

FIG. 1A is schematic diagram of an example driver circuit 100 for an inductive actuator. The driver circuit 100 includes a transistor 102, a clamp control circuit 104, a diode 108, and a resistor 110. The transistor 102 may be n-channel field effect transistor (NFET). The transistor 102 is a pass transistor that controls an inductive actuator. For example, the transistor 102 is turned on to activate the inductive actuator. A coil 106 of an inductive actuator is shown for reference. The transistor 102 has a first terminal (e.g., drain) coupled to the coil 106, a second terminal (e.g., source) coupled to a reference terminal (e.g., ground), and a control terminal (e.g., gate) coupled to an actuator control terminal (ACTCTL). The actuator control terminal may also be coupled to a gate driver or other signal source (not shown) suitable for driving the control terminal of the transistor 102.

The diode 108 and the resistor 110 initiate clamping by the transistor 102, if the transistor 102 transitions from on to off, and the voltage at the first terminal of the transistor 102 increases. The diode 108 has an anode coupled to the first terminal of the transistor 102, and a cathode coupled to a first terminal of the resistor 110. A second terminal of the resistor 110 is coupled to the control terminal of the transistor 102. When the transistor 102 is turned off, and the voltage at the first terminal of the transistor 102 increases, current flows through the diode 108 and the resistor 110. Accordingly, the voltage at the control terminal of the transistor 102 increases to turn on the transistor 102 and conduct current to the reference terminal, discharging the coil 106 and clamping the voltage across the transistor 102.

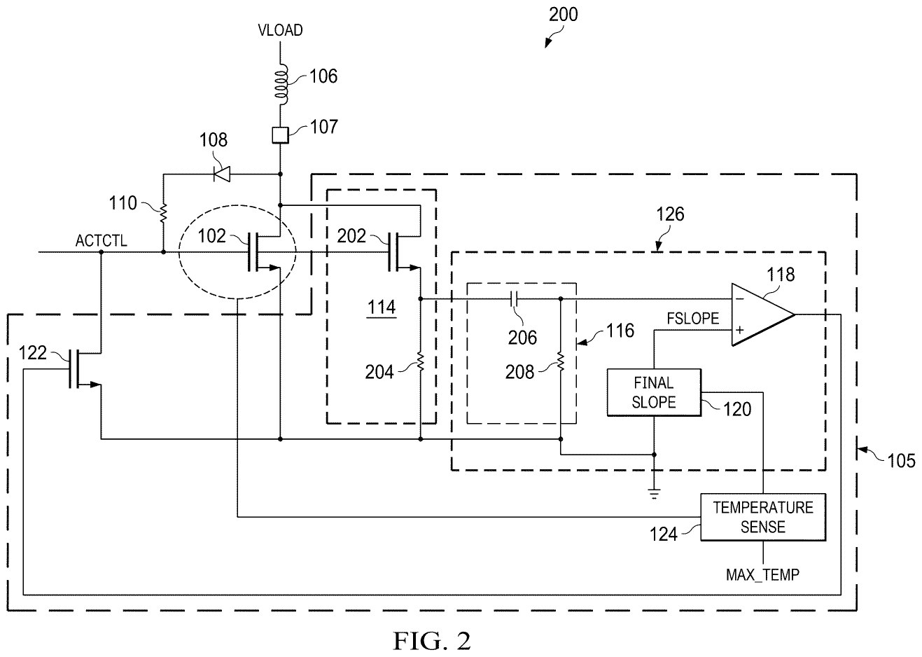

The clamp control circuit 104 controls current flow through the transistor 102 during clamping so that the transistor 102 operates in a safe operating region, which reduces the likelihood of damage to the transistor 102, and extends the operational life of the driver circuit 100. The clamp control circuit 104 includes a current sensor 114, a transistor 122, and a current limit circuit 126. The current sensor 114 measures the current flow through the transistor 102 during clamping. The current sensor 114 may be coupled to the first terminal of the transistor 102 and/or the second terminal of the transistor 102. The current sensor 114 may be implemented as a sense resistor coupled between the first terminal of the transistor 102 and the actuator terminal 107, or coupled between the second terminal of the transistor 102 and the reference terminal. The current sensor 114 may also be implemented as a sense transistor coupled in parallel with the transistor 102 (as shown in FIG. 2).

The current sensor 114 has a sense current output coupled to the current limit circuit 126. The current limit circuit 126 receives a current sense signal from the current sensor 114 and controls clamping by the transistor 102 based on the current sense signal. The current limit circuit 126 includes a filter circuit 116, an amplifier 118, and final slope circuit 120 (also referred to as a slope threshold circuit). The filter circuit 116 has an input coupled to the output of the current sensor 114, and an output coupled to a first input (e.g., an inverting input) of the amplifier 118. In an example, the filter circuit 116 is a high-pass filter circuit that high-pass filters the current sense signal to produce a slope signal that represents the rate of change of current flowing through the transistor 102 during clamping.

The final slope circuit 120 provides a slope threshold signal (FSLOPE) that represents a selected maximum slope of the current flowing through the transistor 102 during clamping. In various examples, the final slope circuit 120 may set FSLOPE based on voltage provided via a digital-to-analog converter (not shown), a voltage provided at a slope input terminal, or other voltage source. An output of the final slope circuit 120, at which FLSLOPE is provided, is coupled to a second input (e.g., a non-inverting input) of the amplifier 118. The amplifier 118 compares FLSLOPE to the slope signal provided by the filter circuit 116 to generate a feedback signal for controlling the transistor 102. An output of the amplifier 118 is coupled to the transistor 122.

The transistor 122 has a first terminal (e.g., drain) coupled to the control terminal of the transistor 102, a second terminal (e.g., source) coupled to the second terminal of the transistor 102, and a control terminal (e.g., gate) coupled to the output of the amplifier 118. The transistor 122 draws current from the control terminal of the transistor 102, to reduce the voltage at the control terminal of the transistor 102 during clamping, based on the feedback signal provided by the amplifier 118. For example, if the slope of current sensed by the current sensor 114 is greater than the slope represented by FSLOPE, then the feedback signal provided by the amplifier 118 reduces the voltage at the control terminal of the transistor 122, which reduces the voltage across the transistor 102, and reduces the slope of the current flowing through the transistor 102. By controlling the current flowing through the transistor 102 based on the slope of the measured current, the clamp control circuit 104 can limit the current flowing through the transistor 102 as needed to reduce damage to the transistor 102 due to excessive temperature.

FIG. 1B is schematic diagram of an example driver circuit 150 for an inductive actuator. The driver circuit 150 is similar to the driver circuit 100, and includes the transistor 102, the actuator terminal 107, the diode 108, and the resistor 110. The driver circuit 150 also includes a clamp control circuit 105. The clamp control circuit 105 is similar to the clamp control circuit 104, and includes the current sensor 114, the transistor 122, and the current limit circuit 126. The clamp control circuit 105 also includes a temperature sense circuit 124. In an example, the temperature sense circuit 124 is a temperature sensor that measures the temperature of the transistor 102. The temperature sense circuit 124 compares the measured temperature of the transistor 102 to a selected maximum temperature, and provides a difference signal representing a difference of the temperature of the transistor 102 and the selected maximum signal to the final slope circuit 120. The final slope circuit 120 applies the difference signal to adjust FLSLOPE. For example, responsive to the difference signal, the final slope circuit 120 reduces the voltage of FLSLOPE. Responsive thereto, the amplifier 118 increases the voltage of the feedback signal provided to the transistor 122, and reduces the current flowing through the transistor 102. Accordingly, the temperature sense circuit 124 enables the temperature of the transistor 102 during clamping to be limited to a range that prevents thermal damage to the transistor 102.

FIG. 2 is a schematic diagram of an example driver circuit 200 for an inductive actuator. The driver circuit 200 is an example of the driver circuit 100. The driver circuit 200 includes the transistor 102, the clamp control circuit 105, the diode 108, and the resistor 110 as described with regard to the driver circuit 100. In the driver circuit 200, the current sensor 114 is implemented using a sense transistor. The current sensor 114 includes a transistor 202 and a resistor 204. The transistor 202 may be an NFET, and may be a scaled replica of the transistor 102. The transistor 202 has a first terminal (e.g., drain) coupled to the first terminal of the transistor 102, a second terminal (e.g., source) coupled to the reference terminal via the resistor 204, and a control terminal (e.g., gate) coupled to the control terminal of the transistor 102. The resistor 204 has a first terminal coupled to the second terminal of the transistor 202, and a second terminal coupled to the reference terminal. The second terminal of the transistor 202 serves as the output of the current sensor 114.

The filter circuit 116 includes a capacitor 206 and a resistor 208. The capacitor 206 has a first terminal coupled to the second terminal of the transistor 202, and a second terminal coupled to first input of the amplifier 118. The resistor 208 has a first terminal coupled to the second terminal of the capacitor 206, and a second terminal coupled to the reference terminal. The filter circuit 116 provides a high-pass filter output signal (a slope signal) that represents the slope of current flowing through the transistor 102.

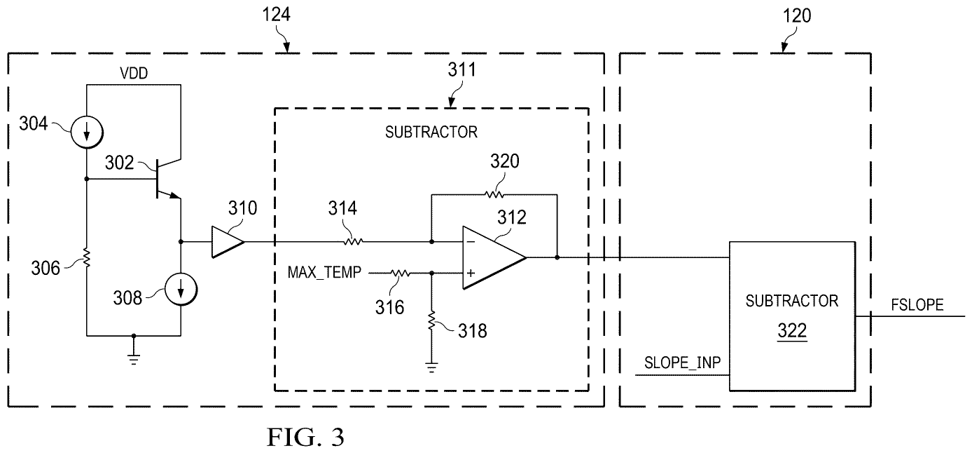

FIG. 3 is a schematic diagram of examples of the final slope circuit 120 and temperature sense circuit 124 suitable for use in the driver circuit 150 or the driver circuit 200. The temperature sense circuit 124 includes a transistor 302, current sources 304 and 308, a resistor 306, a buffer circuit 310, and a subtractor circuit 311. The transistor 302 may be an NPN bipolar transistor. The transistor 302 has a first terminal (e.g., collector) coupled to a power terminal (VDD), a second terminal (e.g., emitter), and a control terminal (e.g., base). The current source 304 has an input coupled to VDD, and an output coupled to the control terminal of the transistor 302. The resistor 306 has a first terminal coupled to the control terminal of the transistor 302, and a second terminal coupled to the reference terminal. The current source 308 has an input coupled to the second terminal of the transistor 302, and an output coupled to the reference terminal. A voltage provided at the second terminal of the transistor 302 is a temperature signal that represents the temperature of the transistor 102. The transistor 302 may be positioned near to the transistor 102 on an integrated circuit to sense the temperature of the transistor 102. As the temperature of a base-emitter junction of the transistor 302 changes (based on change of the temperature of the transistor 102), the temperature sense signal provided by the temperature sense circuit 124 changes.

The buffer circuit 310 may be a unity gain amplifier circuit. The buffer circuit 310 has an input coupled to the second terminal of the transistor 302, and an output. The subtractor circuit 311 includes an amplifier 312 and resistors 314, 316, 318, and 320. A first input of the amplifier 312 is coupled to the output of the buffer circuit 310 via the resistor 314. A first terminal of the resistor 314 is coupled to the first input of the amplifier 312, and a second terminal of the resistor 314 is coupled to the output of the buffer circuit 310. A second input of the amplifier 312 is coupled to a maximum temperature terminal (MAX_TEMP) via the resistor 316. The resistor 316 has a first terminal coupled to the second input of the amplifier 312, and a second terminal coupled to the MAX_TEMP terminal. A voltage representing a maximum selected temperature (e.g., 300° Celsius) of the transistor 102 is provided at the MAX_TEMP terminal. For example, the voltage provided at the MAX_TEMP terminal may be the same as the voltage provided at the output of the temperature sense circuit 124 if the transistor 102 has the maximum selected temperature. The resistor 318 is coupled between the second input of the amplifier 312 and the reference terminal. The resistor 318 has a first terminal coupled to the second input of the amplifier 312, and a second terminal coupled to the reference terminal. The resistor 320 is coupled between the output of the amplifier 312 and the first input of the amplifier 312 for providing negative feedback. The resistor 320 has a first terminal coupled to the output of the amplifier 312, and a second terminal coupled to the first input of the amplifier 312. The amplifier 312 provides an output signal representing the difference of the voltage received from the transistor 302 and the voltage at the MAX_TEMP terminal.

The final slope circuit 120 includes a subtractor circuit 322. The subtractor circuit 322 may be an example of the subtractor circuit 311. A first input of the subtractor circuit 322 is coupled to the output of the subtractor circuit 311. A second input of the subtractor circuit 322 is coupled to a slope input terminal (SLOPE_INP) that provides a voltage representing the selected maximum slope of the current flowing through the transistor 102 during clamping. The voltage provided at SLOPE_INP may be provided via a digital-to-analog converter (not shown), a slope input terminal, or other voltage source. The subtractor circuit 322 has an output at which FSLOPE is provided. FSLOPE may be provided by the subtractor circuit 322 as a difference of the output signal of the subtractor circuit 311 and the voltage at SLOPE_INP. The output of the subtractor circuit 322 is the output of the final slope circuit 120, and as shown in FIGS. 1B and 2, the output of the final slope circuit 120 is coupled to the second input of the amplifier 118.

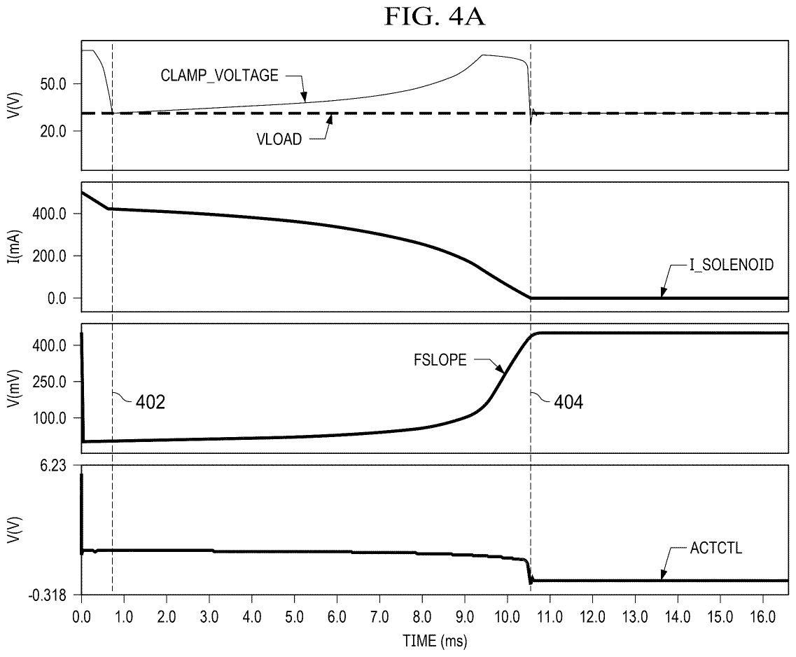

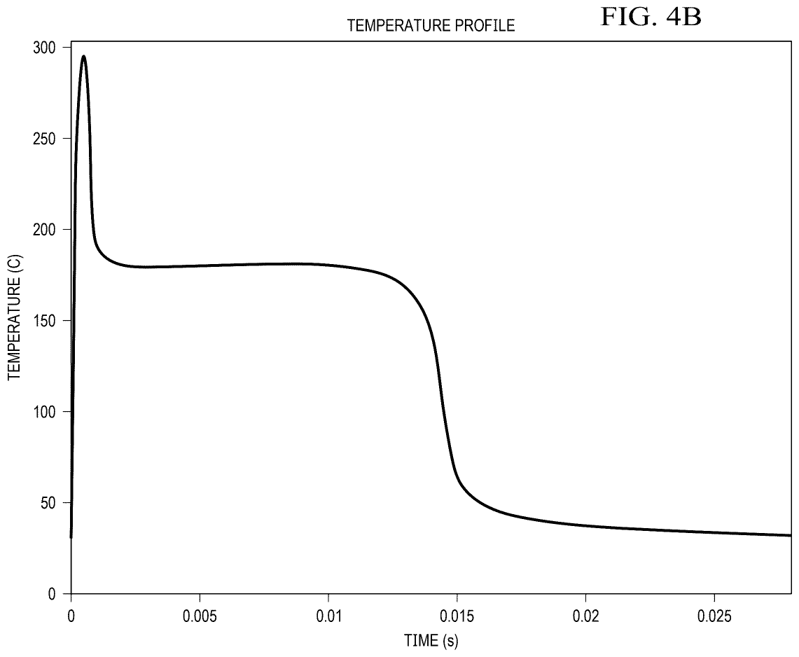

FIG. 4 is a graph of example signals in the driver circuit 200 during clamping. FIG. 4 shows the voltage provided to the coil 106 (VLOAD), the voltage across the transistor 102 (CLAMP_VOLTAGE), the current flowing in the coil 106 (I_SOLENOID), the FSLOPE signal provided to the amplifier 118, and the voltage at the control terminal (ACTCTL) of the transistor 102. VLOAD is about 30 volts. At time 0, the transistor 102 is turned off, CLAMP_VOLTAGE rises to over 70 volts, and the transistor 102 turns on through the diode 108 and the resistor 110. The clamp control circuit 105 senses the current flowing through the transistor 102 and adjusts ACTCTL

The current flowing through the transistor 102 causes the temperature of the transistor 102 to increase. The clamp control circuit 105 senses the temperature of the transistor 102, and as the temperature of the transistor 102 increases to a maximum allowed temperature (e.g., 300° C.), the clamp control circuit 105 reduces the slope of current through the transistor 102 to a minimum value at about 402. As the coil 106 discharges (I_SOLENOID falls), the voltage across the transistor 102 (CLAMP_VOLTAGE) can be increased while maintaining the temperature of the transistor 102 within a desired range (e.g., below 200° C.). Accordingly, the clamp control circuit 105 increases FSLOPE and reduces ACTCTL until the coil 106 is discharged at time 404.

FIG. 4B shows the temperature of the transistor 102 as the coil 106 is discharged. FIG. 4B shows that the temperature of the transistor 102 rises to about 300° C. at the initiation of clamping. In response, the clamp control circuit 105 reduces the current flowing through the transistor 102 to reduce the temperature of the transistor 102, and maintain the temperature of the transistor 102 below 200° C.

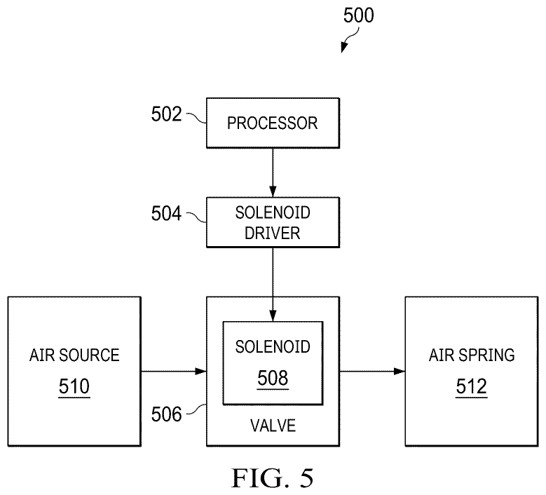

FIG. 5 is a block diagram of an example vehicular active suspension system 500. The vehicular active suspension system 500 includes a processor 502, a solenoid driver 504, a valve 506, an air source 510, and an air spring 512. The valve 506 includes a solenoid 508. The processor 502 is coupled to the solenoid driver 504. The processor 502 may be a general-purpose processor, a microcontroller, or other processor circuit. The solenoid driver 504 may be an example of the driver circuit 100, the driver circuit 150, or the driver circuit 200. The solenoid driver 504 is coupled to the solenoid 508. The solenoid driver 504 controls the solenoid 508 to open and close the valve 506. The valve 506 controls the flow of air from the air source 510 to the air spring 512.

The processor 502 may monitor motion of the vehicle's body, and actuate the valve 506 to control motion of the vehicle's body. Control of the air spring 512 to dampen oscillations of a vehicle's body may require many actuations of the solenoid 508 by the solenoid driver 504. Because the solenoid driver 504 includes the clamp control circuit 104 or the clamp control circuit 105, the temperature of the transistor 102 during clamping is reduced, and the operational life of the solenoid driver 504 is greatly increased. For example, the clamp control circuit 104 or 105 can increase operational life of the solenoid driver 504 from a few thousand cycles to millions of cycles.

While the driver circuits 100, 150, and 200 have been described as implemented using analog circuitry, some examples of the driver circuit 100, the driver circuit 150, or the driver circuit 200 may be implemented using digital circuitry. For example, the filter circuit 116, the amplifier 118, the final slope circuit 120, the subtractor circuit 311, and/or the subtractor circuit 322 may be implemented using digital circuitry to perform the functions described herein.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) (n-type transistor) or a p-channel FET (PFET)) (p-type transistor)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input (or transistor control terminal) is the gate, and the current terminals are the drain and source. In the context of a BJT, the control input is the base, and the current terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A circuit comprising:
a first transistor having a first terminal, a second terminal, and a control terminal;
a second transistor having a first terminal coupled to the first terminal of the first transistor, a second terminal, and a control terminal coupled to the control terminal of the first transistor;
a third transistor having a first terminal coupled to the control terminal of the first transistor, a second terminal coupled to the second terminal of the first transistor, and a control terminal; and
a current limit circuit having an input coupled to the second terminal of the second transistor, and an output coupled to the control terminal of the third transistor.

2. The circuit of claim 1, further comprising a diode and a resistor coupled in series between the first terminal of the first transistor and the control terminal of the first transistor.

3. The circuit of claim 1, further comprising a resistor having a first terminal coupled to the second terminal of the second transistor, and a second terminal coupled to the second terminal of the first transistor.

4. The circuit of claim 1, wherein the current limit circuit includes:
a filter circuit including:
a capacitor having a first terminal coupled to the second terminal of the second transistor, and a second terminal; and
a resistor having a first terminal coupled to the second terminal of the capacitor, and a second terminal coupled to the second terminal of the first transistor.

5. The circuit of claim 4, wherein the current limit circuit includes:
an amplifier having a first input coupled to the second terminal of the capacitor, a second input, and an output coupled to the control terminal of the third transistor; and
a voltage source having an output coupled to the second input of the amplifier.

6. The circuit of claim 5, wherein:
the voltage source has an input; and
the circuit includes a temperature sensor having an output coupled to the input of the voltage source.

7. The circuit of claim 6, wherein the temperature sensor is configured to sense a temperature of the first transistor.

8. A circuit comprising:
a first transistor having a first terminal, a second terminal, and a control terminal;
a current sensor coupled to the first terminal or the second terminal of the first transistor;
a filter circuit having a first terminal coupled to current sensor, and a second terminal coupled to the second terminal of the first transistor, and a third terminal;
an amplifier having a first input coupled to the third terminal of the filter circuit, a second input coupled to a slope input terminal, and an output; and
a second transistor having a first terminal coupled to the control terminal of the first transistor, a second terminal coupled to the second terminal of the first transistor, and a control terminal coupled to the output of the amplifier.

9. The circuit of claim 8, wherein the current sensor includes:
a third transistor having a first terminal coupled to the first terminal of the first transistor, a second terminal coupled to the first terminal of the filter circuit, and a control terminal coupled to the control terminal of the first transistor; and
a resistor having a first terminal coupled to the second terminal of the third transistor, and a second terminal coupled to the second terminal of the first transistor.

10. The circuit of claim 9, wherein the filter circuit includes:
a capacitor having a first terminal coupled to the second terminal of the third transistor, and a second terminal coupled to the first input of the amplifier; and
a resistor having a first terminal coupled to the second terminal of the capacitor, and a second terminal coupled to the second terminal of the first transistor.

11. The circuit of claim 8 further comprising a diode and a resistor coupled in series between the first terminal of the first transistor and the control terminal of the first transistor.

12. The circuit of claim 8, further comprising a voltage source coupled to the slope input terminal.

13. The circuit of claim 12, further comprising a temperature sensor having an output coupled to the voltage source.

14. The circuit of claim 13, wherein:
the temperature sensor is configured to sense a temperature of the first transistor and provide, at the output of the temperature sensor, a temperature sense signal representing the temperature of the first transistor; and
the voltage source is configured to adjust a voltage provided by the voltage source based on the temperature sense signal.

15. A circuit comprising:
a first transistor having a first terminal, a second terminal, and a control terminal;
a current sensor coupled to the first terminal or the second terminal of the first transistor;
a filter circuit having a first terminal coupled to the current sensor, and a second terminal coupled to the second terminal of the first transistor, and a third terminal;
an amplifier having a first input coupled to the third terminal of the filter circuit, a second input, and an output;
a slope threshold circuit having an input, and an output coupled to the second input of the amplifier;
a temperature sense circuit having an output coupled to the input of the slope threshold circuit; and
a second transistor having a first terminal coupled to the control terminal of the first transistor, a second terminal coupled to the second terminal of the first transistor, and a control terminal coupled to the output of the amplifier.

16. The circuit of claim 15, wherein the current sensor includes:
a third transistor having a first terminal coupled to the first terminal of the first transistor, a second terminal coupled to the first terminal of the filter circuit, and a control terminal coupled to the control terminal of the first transistor; and
a resistor having a first terminal coupled to the second terminal of the third transistor, and a second terminal coupled to the second terminal of the first transistor.

17. The circuit of claim 16, wherein the filter circuit includes:
a capacitor having a first terminal coupled to the second terminal of the third transistor, and a second terminal coupled to the first input of the amplifier; and
a resistor having a first terminal coupled to the second terminal of the capacitor, and a second terminal coupled to the second terminal of the first transistor.

18. The circuit of claim 15 further comprising a diode and a resistor coupled in series between the first terminal of the first transistor and the control terminal of the first transistor.

19. The circuit of claim 15, wherein:
the temperature sense circuit is configured to sense a temperature of the first transistor and provide, at the output of the temperature sense circuit, a temperature sense signal representing the temperature of the first transistor; and
the slope threshold circuit is configured to adjust a voltage provided at the output of the slope threshold circuit based on the temperature sense signal.

20. The circuit of claim 19, wherein the temperature sense circuit includes:
a third transistor configured to sense the temperature of the first transistor, the third transistor having an emitter at which a temperature signal is provided; and
a subtractor circuit having a first input coupled to the emitter, a second input coupled to a maximum temperature terminal, and an output coupled to the input of the slope threshold circuit.
